(19) United States
(12) Patent Application Publication
(10) Pub. No.: US 2014/0323059 A1
(43) Pub. Date: Oct. 30, 2014

(54) MOBILE COMMUNICATION TERMINAL TEST DEVICE AND MOBILE COMMUNICATION TERMINAL TEST METHOD

(71) Applicant: ANRITSU CORPORATION, Kanagawa (JP)

(72) Inventors: Satoshi Wakasa, Kanagawa (JP); Tomoyuki Fujiwara, Kanagawa (JP)

(73) Assignee: ANRITSU CORPORATION, Kanagawa (JP)

(21) Appl. No.: 14/242,209

(22) Filed: Apr. 1, 2014

(30) Foreign Application Priority Data
Apr. 24, 2013 (JP) 2013-090824

(51) Int. Cl. H04B 17/00

(52) U.S. Cl. CPC H04B 17/00
USPC 455/67.14

(57) ABSTRACT

It is possible to easily check the state of cells when communication using a plurality of cells is tested. A mobile communication terminal test device 10 that communicates with a mobile communication terminal 50 using a plurality of cells to test the mobile communication terminal includes a display unit 21, a cell state determination unit 19 that determines a state of the plurality of cells in the communication, and a display control unit 20 that displays a screen indicating the determined state of the plurality of cells, which corresponds to an elapsed time in the communication, on the display unit.

### TECHNICAL FIELD

The present invention relates to a mobile communication terminal test device that communicates with a mobile communication terminal to perform a test operation, such as an operation of evaluating the performance of the mobile communication terminal, and can display various kinds of information, such as information about the state of communication.

### BACKGROUND ART

For example, when mobile communication terminals typified by mobile phones are developed, a mobile communication terminal test device is used to test whether the mobile communication terminal under development operates as designed and whether the mobile communication terminal normally operates according to a communication standard. A test scenario in which the operation sequence and communication sequence of the mobile communication terminal test device are described is created in advance and stored, and the mobile communication terminal test device operates as a pseudo-base station apparatus which simulates the base station according to the test scenario. Then, the tester (developer) uses the mobile communication terminal test device to communicate with the mobile communication terminal to be tested and checks the operating state of the mobile communication terminal and a communication state between the mobile communication terminal and the base station with reference to log information during communication, thereby testing whether the mobile communication terminal can normally perform communication. For example, Patent Document 1 discloses an example of the mobile communication terminal test device.

### RELATED ART DOCUMENT

### Patent Document

[Patent Document 1] JP-A-2009-147640

### DISCLOSURE OF THE INVENTION

### Problem that the Invention is to Solve

In recent years, in the mobile communication standard, a method has been examined which performs communication using a bundle of a plurality of communication bands in order to improve the communication rate. In a mobile communication system, such as a cellular communication system, in some cases, a communication area covered by the base station and the unit of a communication band (frequency band) in the communication area are referred to as a “cell”. Hereinafter, a communication zone in which communication is performed between the base station and the mobile communication terminal is referred to as a “cell”.

For example, in LTE-Advanced that is the next-generation standard of Long Term Evolution (LTE), which is a mobile communication standard examined by Third Generation Partnership Project (3GPP), carrier aggregation using a maximum of five cells is defined. In addition, in Wideband Code Division Multiple Access (W-CDMA) which is the third-generation (3G) mobile communication standard, Dual Cell High Speed Downlink Packet Access (DC-HSDPA) using two cells at the same time is defined.

In the communication system using a plurality of cells, in general, communication between the base station and the mobile communication terminal is performed in one cell. When communication is performed with a high communication rate, communication is performed by a bundle of other cells. A mobile communication terminal test device which can receive and transmit signals from a plurality of cells and perform communication is needed in order to test the mobile communication terminal corresponding to the communication system.

However, the mobile communication terminal test device is configured so as to correspond to various tests, depending on settings. The operation of the mobile communication terminal test device for a plurality of cells is dynamically changed depending on settings. Since the state of the cells during communication is related to the operation of the mobile communication terminal, the tester wants to check the state of the cells during or after a test.

However, in order to check the state of the cells, it is necessary to analyze and check the content of the test scenario in which the settings and test procedure of the mobile communication terminal test device are described or log information during communication. In this case, it takes a lot of time and effort to analyze and check the content of the test scenario and it is difficult to analyze and check the content of the test scenario or the log information.

The invention has been made in view of the above-mentioned problems and an object of the invention is to provide a mobile communication terminal test device and a mobile communication terminal test method which can easily check the state of cells when communication using a plurality of cells is tested.

### Means for Solving the Problem

According to a first aspect of the invention, there is provided a mobile communication terminal test device that communicates with a mobile communication terminal (50) using a plurality of cells to test the mobile communication terminal. The mobile communication terminal test device includes: a display unit (21); a cell state determination unit (19) that determines a state of the plurality of cells in the communication; and a display control unit (20) that displays a screen indicating the determined state of the plurality of cells, which corresponds to an elapsed time in the communication, on the display unit.

According to the above-mentioned structure, when communication using a plurality of cells is tested, it is possible to easily check the state of each cell.

According to a second aspect of the invention, the mobile communication terminal test device according to the first aspect may further include a scenario processing unit (16) that controls a procedure of the communication according to a test scenario. The cell state determination unit may acquire scenario information when the test scenario is performed and determine the state of the plurality of cells before or during the test on the basis of the acquired scenario information.

According to the above-mentioned structure, it is possible to determine the state of a plurality of cells before or during a test on the basis of the acquired scenario information.

According to a third aspect of the invention, the mobile communication terminal test device according to the first aspect may further include a layer processing unit (13) that performs a process related to a hierarchized communication protocol in the communication, a log data generation unit (17) that generates log data including log information of the process performed by the layer processing unit, and a log data storage unit (18) that stores the log data. The cell state determination unit may acquire the log information of the stored log data and determine the state of the plurality of cells at a predetermined time in the test on the basis of the acquired log information.

According to the above-mentioned structure, it is possible to determine the state of a plurality of cells at a predetermined time in the test on the basis of the acquired log information.

According to a fourth aspect of the invention, in the mobile communication terminal test device according to the third aspect, the display control unit may display the state of the plurality of cells and display a log including the log information at the time, in response to a log display operation instruction from an operation unit.

According to the above-mentioned structure, it is possible to easily check the log information at the time instructed by the operation unit.

According to a fifth aspect of the invention, in the mobile communication terminal test device according to the first aspect, the cell state determination unit may determine whether each cell is a primary cell or one of secondary cells as the state of the plurality of cells, and the display control unit may display the determined state of the each cell so as to be recognized.

According to the above-mentioned structure, it is possible to easily check the state of the primary cell or the secondary cells in communication based on, for example, LTE-Advanced, which is a communication standard.

According to a sixth aspect of the invention, in the mobile communication terminal test device according to the first aspect, the cell state determination unit may determine an activation or deactivation state of each cell as the state of the plurality of cells, and the display control unit may display the determined activation or deactivation state so as to be recognized.

According to the above-mentioned structure, it is possible to easily check the activation or deactivation state in communication based on, for example, LTE-Advanced, which is a communication standard. In particular, it is possible to easily recognize the activation or deactivation state corresponding to the traffic of, for example, the secondary cells.

According to a seventh aspect of the invention, in the mobile communication terminal test device according to the third aspect, the layer processing unit may perform a process of simulating a plurality of base stations, the cell state determination unit may determine whether a handover occurs between different base stations, and the display control unit may display the determined handover state so as to be recognized.

According to the above-mentioned structure, it is possible to easily check the handover state between cells, such as whether handover occurs, the start/end of handover, a handover source cell, and a handover target cell.

According to an eighth aspect of the invention, in the mobile communication terminal test device according to the seventh aspect, the display control unit may display the state of the handover including a handover procedure time related to the handover, in response to a handover display operation instruction from an operation unit (22).

According to the above-mentioned structure, it is possible to easily check the handover procedure time related to the handover instructed by the operation unit.

According to a ninth aspect of the invention, there is provided a mobile communication terminal test method that communicates with a mobile communication terminal (50) using a plurality of cells to test the mobile communication terminal. The mobile communication terminal test method includes a cell state determination step of determining a state of the plurality of cells in the communication and a display step of displaying a screen indicating the determined state of the plurality of cells which corresponds to an elapsed time in the communication.

According to the above-mentioned procedure, it is possible to easily check the state of each cell when communication using a plurality of cells is tested.

### Advantage of the Invention

According to the invention, it is possible to easily check the state of cells when communication using a plurality of cells is tested.

### BRIEF DESCRIPTION OF THE DRAWINGS

FIG. 1 is a block diagram illustrating the structure of a mobile communication terminal test device according to a first embodiment of the invention.

FIG. 2 is a diagram illustrating an example of log data created in a log data generation unit.

FIG. 3 is a diagram illustrating an example of the display of a log on a display screen of a display unit.

FIG. 4 is a diagram illustrating an example of the display of the state of cells on the display unit in the first embodiment.

FIG. 5 is a diagram illustrating an example of information which is used to determine the addition (Configuration) and deletion (Release) of a secondary cell.

FIG. 6 is a diagram illustrating an example of information which is used to determine the switching time between the activation/deactivation of the secondary cell.

FIG. 7 is a diagram illustrating log information which is an example of information used to determine the activation/deactivation state of the secondary cell.

FIG. 8 is a block diagram illustrating the structure of a mobile communication terminal test device according to a second embodiment of the invention.

FIG. 9 is a diagram illustrating an example of the display of the state of cells on a display unit in the second embodiment.

FIG. 10 is a diagram illustrating an example of information used to determine a handover start time.

FIG. 11 is a diagram illustrating an example of information used to determine a handover end time.

FIG. 12 is a diagram illustrating a first modification example of the display of the state of the cells on the display unit in this embodiment.

FIG. 13 is a diagram illustrating a second modification example of the display of the state of the cells on the display unit in this embodiment.

FIG. 14 is a flowchart illustrating the procedure of a process related to the check of a test scenario before a test.

FIG. 15 is a flowchart illustrating the procedure of a process related to the real-time display of the state of cells during a test.

FIG. 16 is a flowchart illustrating the procedure of a process related to the check of log information and the display of the state of cells after a test.

### BEST MODE FOR CARRYING OUT THE INVENTION

Hereinafter, embodiments of the invention will be described with reference to the drawings.

A mobile communication terminal test device according to an embodiment of the invention functions as a pseudo base station device, instead of the actual network, and performs test operations, such as an operation of checking the operating state of a mobile communication terminal and an operation of evaluating the performance of the mobile communication terminal. The mobile communication terminal test device can communicate with the mobile communication terminal to be tested, acquire log information during communication, store the log information, and display the log information. For example, terminals which perform communication based on a predetermined communication standard, such as mobile phones, smart phones, data communication terminals, and various types of mobile communication terminals, are used as the mobile communication terminal. In this embodiment, an example in which a mobile communication terminal that can perform communication based on LTE-Advanced, which is a communication standard, is used as the mobile communication terminal to be tested will be described.

### First Embodiment

### Structure of First Embodiment

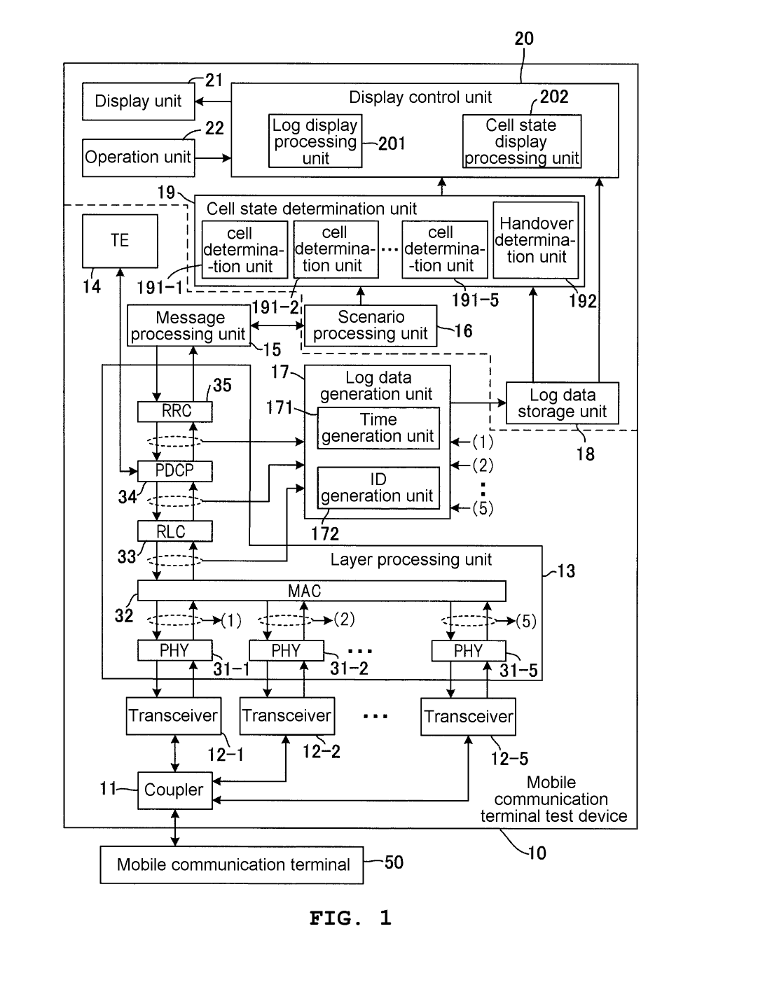

FIG. 1 is a block diagram illustrating the structure of a mobile communication terminal test device according to a first embodiment of the invention.

A mobile communication terminal test device 10 according to the first embodiment is connected to a mobile communication terminal 50 and communicates with the mobile communication terminal 50 to acquire communication information including log information during communication. The mobile communication terminal test device 10 and the mobile communication terminal 50 are connected to each other by a wired transmission path, such as a coaxial cable.

The mobile communication terminal test device 10 includes a coupler 11, transceivers 12-1 to 12-5, a layer processing unit 13, a terminal equipment (TE) unit 14, a message processing unit 15, a scenario processing unit 16, a log data generation unit 17, a log data storage unit 18, a cell state determination unit 19, a display control unit 20, a display unit 21, and an operation unit 22.

The first embodiment shows a structure in which the mobile communication terminal test device 10 simulates the operation of one base station including a plurality of cells and communicates with the mobile communication terminal 50 to be tested using the plurality of cells.

The coupler 11 is a circuit element which connects the mobile communication terminal 50 to be tested and the transceivers 12-1 to 12-5. The coupler 11 transmits transmission signals output from the transceivers 12-1 to 12-5 to the mobile communication terminal 50 and transmits reception signals received from the mobile communication terminal 50 to the transceivers 12-1 to 12-5.

The transceivers 12-1 to 12-5 each include a transmitting and receiving circuit including a radio frequency (RF) unit and a baseband unit, perform transmission, reception, and modulation, and demodulation processes for communication signals, and perform communication of signals in an RF band. Specifically, the transceivers 12-1 to 12-5 generate a transmission signal in a baseband from the signal output from the layer processing unit 13, convert the frequency of the transmission signal into a frequency in the RF band, amplify the power of the transmission signal, and transmit the amplified transmission signal to the mobile communication terminal 50 through the coupler 11. In addition, the transceivers 12-1 to 12-5 convert the frequency of the signal in RF band, which has been transmitted from the mobile communication terminal 50 and then received through the coupler 11, into a frequency in the baseband band, acquire the signal as a reception signal, and input the reception signal to the layer processing unit 13. In this embodiment, an example in which five transceivers 12-1 to 12-5 are provided such that communication can be performed by a maximum of five cells will be described.

The mobile communication terminal test device 10 and the mobile communication terminal 50 may be connected by a wireless transmission path and communication may be performed between the mobile communication terminal test device 10 and the mobile communication terminal 50 by radio waves. In addition, the RF units may be omitted in the transceivers 12-1 to 12-5 or communication may be performed between the mobile communication terminal test device 10 and the mobile communication terminal 50 through the RF units by the signals in the baseband band.

The layer processing unit 13 performs signal processing based on a predetermined communication protocol and processes a communication protocol group with a layer structure including a plurality of layers. The layer processing unit 13 includes physical layer (PHY) units 31-1 to 31-5, a media access control layer (MAC) unit 32, a radio link control layer (RLC) unit 33, a packet data convergence protocol layer (PDCP) unit 34, and a radio resource control layer (RRC) unit 35.

In the layer processing unit 13, the layers operate in cooperation with each other. The layer processing unit 13 controls the transmission and reception of information by a protocol corresponding to the communication system and extracts a communication sequence and communication content as log information. In addition, the layer processing unit 13 detects error information (or information indicating the state of each layer) in communication. The log information and the error information acquired by the layer processing unit 13 are input to the log data generation unit 17.

The TE unit 14 has a terminal function and is, for example, a server, such as a mail server or a moving picture server, or a data terminal, such as a video phone terminal. The TE unit 14 operates as a terminal device which executes various applications, and transmits and receives data to and from the mobile communication terminal 50.

The message processing unit 15 processes various messages exchanged between the mobile communication terminal test device 10 and the mobile communication terminal 50. The message processing unit 15 creates a request message to be transmitted to the mobile communication terminal 50 in response to an instruction based on a test scenario from the scenario processing unit 16 and outputs the request message to the layer processing unit 13. In addition, the message processing unit 15 acquires a response message which has been received from the mobile communication terminal 50 and then decoded by the layer processing unit 13 and notifies the scenario processing unit 16 of the response message.

The scenario processing unit 16 stores the test scenario in which the settings of the mobile communication terminal test device 10 and a test sequence are described and instructs each unit to perform each procedure of the test according to the test scenario. That is, the scenario processing unit 16 functions as a control unit which controls the operation of the mobile communication terminal test device 10. For simplicity of illustration, a portion of the connection between the scenario processing unit 16 and each unit is not shown in FIG. 1. The settings of the mobile communication terminal test device in the test to be performed and the test procedure, such as an operation sequence and a communication sequence, are described in the test scenario.

The scenario processing unit 16 transmits an instruction to create a request message to the message processing unit 15 on the basis of the test scenario. In addition, the scenario processing unit 16 outputs information about each procedure to be performed according to the test scenario to the log data generation unit 17. The scenario processing unit 16 outputs, for example, scenario information about the state of cells as the state of the test procedure which is currently being performed according to the test scenario to the cell state determination unit 19.

The log data generation unit 17 generates log data including the log information and the error information for each process of each layer in the layer processing unit 13 as records in each procedure of the test. The log data generation unit 17 includes a time generation unit 171 which generates time information and an ID generation unit 172 which generates identification (ID) information. The log data generation unit 17 receives information including the content of the processes between the layers in the layer processing unit 13 and generates log data in which the log information and the error information are associated with the ID information and the time information, as represented by a dashed ellipse and an arrow in FIG. 1. In FIG. 1, (1) to (5) indicate the correspondence of each path through which information including the content of the processes between the PHY units 31-1 to 31-5 and the MAC unit 32 is input to the log data generation unit 17.

The log data storage unit 18 stores the log data generated by the log data generation unit 17. The log data storage unit 18 reads, for example, log information about the state of the cells as the state related to the test procedure performed according to the test scenario and outputs the log information to the cell state determination unit 19. In addition, the log data storage unit 18 reads log information corresponding to specific conditions, such as a specific time, an ID, the content of messages, and the content of errors, and outputs the log information to the display control unit 20.

The cell state determination unit 19 includes cell determination units 191-1 to 191-5 which determine the activation state of five cells, that is, cell 1 to cell 5, as the state of the cells which communicate with the mobile communication terminal 50 and a handover determination unit 192 which determines the state of handover between a plurality of cells. The cell state determination unit 19 acquires information about the state of the cells during a test, on the basis of the scenario information from the scenario processing unit 16 or the log information from the log data storage unit 18, and determines the state of each of the plurality of cells.

The state of the cells includes, for example, the activation/deactivation state of each cell, the state of a primary cell/secondary cells when communication using a bundle of a plurality of cells is performed by carrier aggregation, the type of base station, and the occurrence/end state of handover.

The display control unit 20 controls the display of the mobile communication terminal test device 10, receives an operation instruction from the operation unit 22, performs a process of generating display information in response to the operation instruction, and outputs the display information to the display unit 21. The display control unit 20 includes a log display processing unit 201 which processes log display information and a cell state display processing unit 202 which processes cell state display information. As the log display, for example, text information including log information which the tester wants to visibly recognize, such as log information for a specific period of time and log information including a specific message, is displayed in response to the operation instruction. As the display of the state of the cells, graphic information in which the state of each cell is represented by for example, a distinguishable color, shape, or figure such that the tester can visually distinguish the state of each cell with ease is displayed in response to the operation instruction.

The display unit 21 includes, for example, a liquid crystal display and displays various kinds of information about the mobile communication terminal test device 10 on a display screen. For example, the display unit 21 displays the log or the state of the cells, displays the log and the state of the cells at the same time, displays the operating state of the device, or displays the set state of the device.

The operation unit 22 includes at least one of various types of operation input devices, such as a button, a switch, and a touch panel, and notifies the corresponding processing unit, such as the display control unit 20, of the input of an operation instruction corresponding to the operation of the tester.

In FIG. 1, the layer processing unit 13, the TE unit 14, the message processing unit 15, the scenario processing unit 16, the log data generation unit 17, the log data storage unit 18, the cell state determination unit 19, and the display control unit 20 are formed by an information processing circuit or a computer including a processor and a memory and implement the functions of each unit.

### <Content of Log Data>

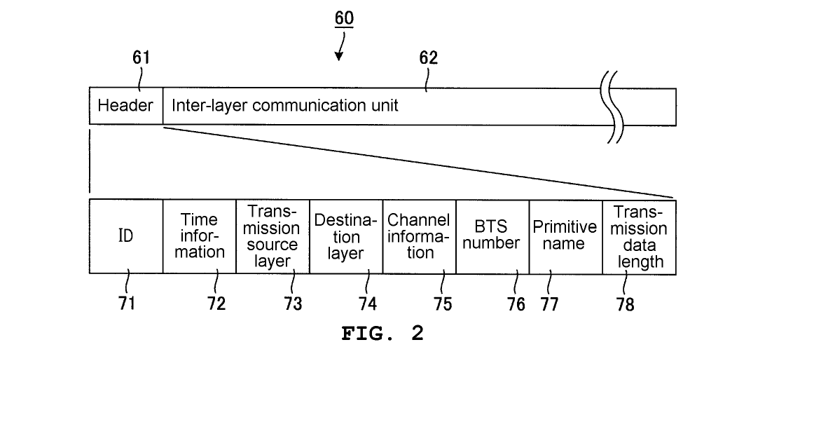

Here, the log data including the log information will be described. FIG. 2 is a diagram illustrating an example of the log data created by the log data generation unit 17.

The log data 60 includes a header 61 and inter-layer communication data 62. The header 61 includes an ID 71, time information 72, a transmission source layer 73, a destination layer 74, channel information 75, a base transceiver station (BTS) number 76, a primitive name 77, and a communication data length 78. The inter-layer communication data 62 is raw data which is exchanged between the layers.

The ID 71 is information for identifying the log data 60 and is, for example, numbers which are given in time series. The time information 72 is information indicating the time when the log data 60 is acquired. The transmission source layer 73 is information indicating the transmission source layer of the inter-layer communication data 62 and the destination layer 74 is information indicating the destination layer of the inter-layer communication data 62. The channel information 75 is information indicating a communication channel and is represented by an identifier and a number which are allocated to each channel in advance. The BTS number 76 is identification information indicating a base station which performs communication and is represented by a number which is allocated to each base station in advance. The primitive name 77 is information indicating the type and name of a primitive (a form indicating the content of a command, such as a setting command, in the process between the layers). The communication data length 78 is information indicating the length of the inter-layer communication data 62.

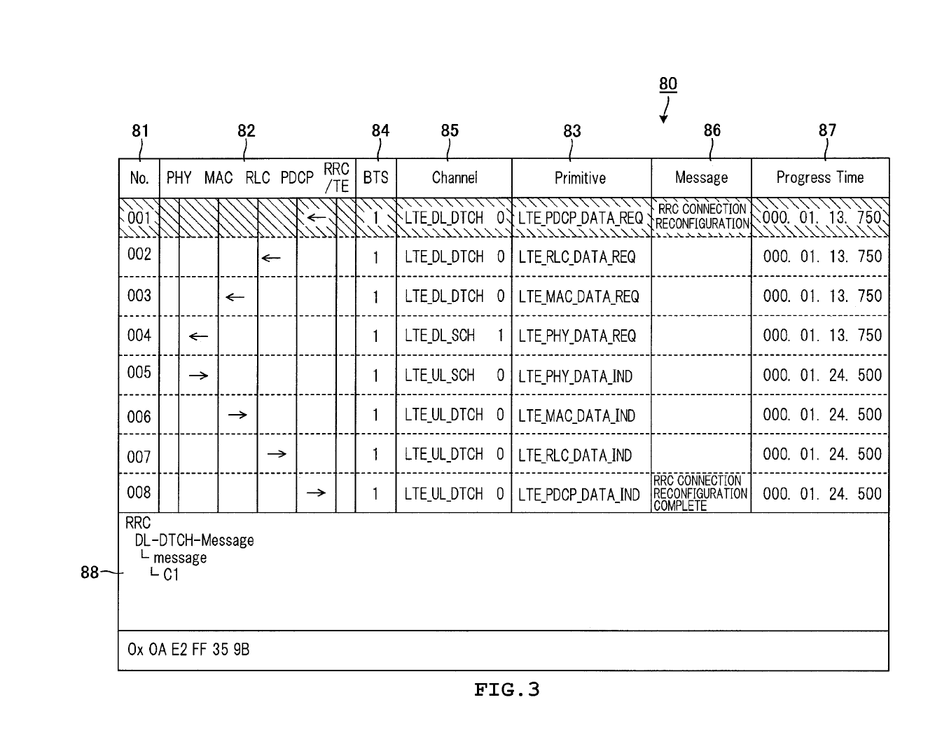

Next, the display (log display) of the log information will be described. FIG. 3 is a diagram illustrating an example of the display of the log on the display screen of the display unit 21.

The log display processing unit 201 of the display control unit 20 reads log data to be displayed from the log data storage unit 18, creates display information for log display, and outputs the display information to the display unit 21. Then, a log display 80 shown in FIG. 3 is displayed on the display screen of the display unit 21.

The log display 80 includes a log number (No.) 81, a layer (PHY, MAC, RLC, PDCP, and RRC/TE) 82, a primitive type (Primitive) 83, a BTS number (BTS) 84, channel information (Channel) 85, a message name (Message) 86, and time information (Progress Time) 87.

Logs of each process are displayed in time series in an upper part of the log display 80 in a table shape in chronological order of the time information 87. Content indicating the content of data for a highlighted designated log which is selected by the tester is displayed in a lower part of the log display 80. Actual data which is represented by a hexadecimal value is displayed at the bottom of the content 88.

The log number 81 is information indicating ID information which is formed by numbers for identifying the log of each process, on the basis of the ID 71 of the log data 60. The layer 82 is information which indicates the flow (the transmission source and destination layers) of the information of the primitive in the layer processing unit 13 using an arrow, on the basis of the transmission source layer 73 and the destination layer 74 of the log data 60. The primitive type 83 is information which indicates the type and name of the primitive, on the basis of the primitive name 77 of the log data 60.

The BTS number 84 is information which indicates the number of the base station that performs communication, on the basis of the BTS number 76 of the log data 60. The channel information 85 is information which indicates the channel through which communication is performed, on the basis of the channel information 75 of the log data 60. The message name 86 is information which indicates the name of a message that is transmitted and received between the layers, on the basis of message description information in the inter-layer communication data 62 of the log data 60. The message name 86 is omitted, depending on a log. The time information 87 is information which indicates the time when data for each process is transmitted and received, on the basis of the time information 72 of the log data 60.

An example of the first row of the log display 80 shown in FIG. 3 (log information with number “001”) indicates that, at a time “000.01.13.750”, as data transmitted from a first base station to the mobile communication terminal, the processing of a primitive “LTE#PDCP#DATA#REQ” (a request to transmit data to the PDCP) is performed and a message “RRC Connection Reconfiguration” (reconfiguration of RRC connection) is transmitted from the RRC unit 35 to the PDCP unit 34 through a channel “LTE#DL#DTCH 0” ((Downlink) zeroth dedicate traffic channel).

### <Operation of First Embodiment (Display of Cell State)>

Next, the display (cell state display) of the state of the cells in the first embodiment will be described.

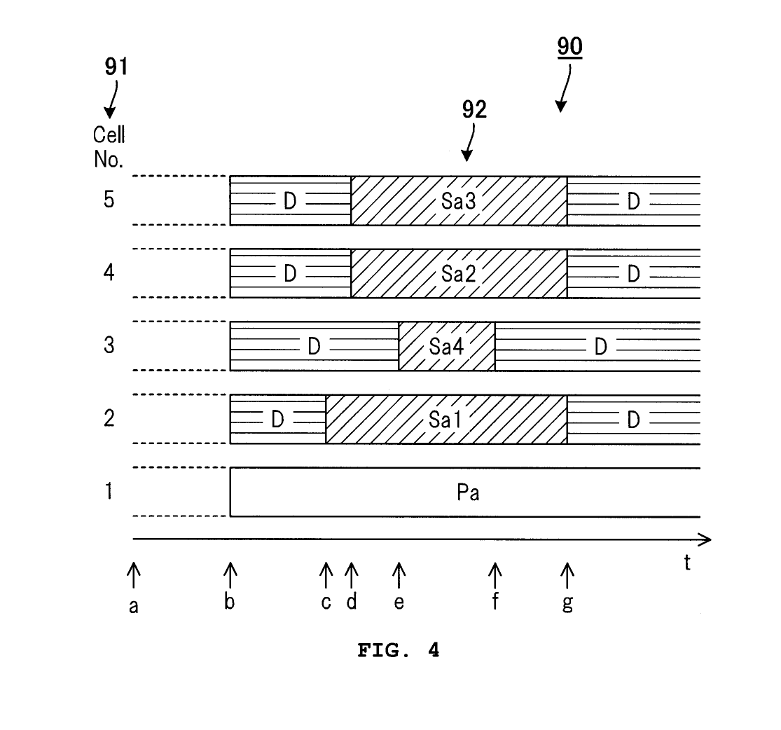

FIG. 4 is a diagram illustrating an example of the display of the state of the cells on the display unit 21 in the first embodiment. FIG. 4 shows an example in which communication using a maximum of five cells can be performed by carrier aggregation and communication using a bundle of a plurality of cells is performed depending on the amount of communication. Here, a case in which the mobile communication terminal test device 10 simulates the operation of a base station a and communicates with the mobile communication terminal 50 to be tested will be described.

When the state of the cells is displayed during a test, the cell state determination unit 19 acquires scenario information from the scenario processing unit 16 and determines the state of the cells from information about the state of the cells in the test scenario, using the cell determination units 191-1 to 191-5.

When the state of the cells is displayed after the test ends, the cell state determination unit 19 acquires log information from the log data storage unit 18 and determines the state of the cells from information about the state of the cells in the log information, using the cell determination units 191-1 to 191-5, similarly to the scenario information.

At that time, for the state of each of a plurality of cells, the cell state determination unit 19 determines the activation/deactivation state of each of cells 1 to 5 and determines whether the cell in the activation state is a primary cell or one of secondary cells. The determination of the state of the cells will be described in detail below.

The cell state display processing unit 202 of the display control unit 20 acquires information about the determination result of the state of the cells by the cell state determination unit 19 and the scenario information or log information used to determine the state of the cells, creates display information for displaying the state of the cells, and outputs the display information to the display unit 21. In this way, a cell state display 90 shown in FIG. 4 is displayed on the display screen of the display unit 21.

The cell state display 90 includes a cell number (Cell No.) display 91 and a state display 92. The cell number display 91 is information indicating the ID information (cell number) of cells which are allocated to numbers 1 to 5 in advance. The state display 92 is information which can identify the state of cell numbers 1 to 5 (cell 1 to cell 5). A plurality of cells are arranged in the longitudinal direction of FIG. 4. In the example shown in FIG. 4, a case in which the primary cell is in the activation state is represented by “P”, a case in which the secondary cell is in the deactivation state is represented by “D”, and a case in which the secondary cell is in the activation state is represented by “S1” to “S4”. In addition, a small letter “a” in “Pa” or “Sa1” indicates the communication state of the base station a.

In FIG. 4, the lateral direction indicates time and the state of the cells is changed from the left to the right of FIG. 4 over time.

Next, the state of the cells at times a to g will be described.

At the time a, the mobile communication terminal 50 and the mobile communication terminal test device 10 do not communicate with each other. In this case, the mobile communication terminal 50 does not operate or the registration of the position of the mobile communication terminal 50 has been completed.

At the time b, in the base station simulated by the mobile communication terminal test device 10, cell 1 is set as the primary cell of the base station a and is activated and communication with the mobile communication terminal 50 by cell 1 starts (cell 1 . . . “Pa”). In addition, cells 2 to 5 are set as the secondary cells of the base station a and are deactivated (cells 2 to 5 . . . “D”). Since the primary cell transmits and receives control signals, it is constantly activated when communication is established.

At the time c, the amount of communication between the mobile communication terminal 50 and the base station a of the mobile communication terminal test device 10 increases, cell 2 is set as the first secondary cell of the base station a and is activated, and communication with the mobile communication terminal 50 is performed by cell 1 and cell 2 (cell 2 . . . “D”→“Sa1”).

At the time d, the amount of communication between the mobile communication terminal 50 and the base station a of the mobile communication terminal test device 10 further increases, cell 4 and cell 5 are set as the second and third secondary cells of the base station a and are activated, and communication with the mobile communication terminal 50 is performed by cell 1, cell 2, cell 4, and cell 5 (cell 4 . . . “D”→“Sa2”, cell 5 . . . “D”→“Sa3”).

At the time e, the amount of communication between the mobile communication terminal 50 and the base station a of the mobile communication terminal test device 10 further increases, cell 3 is set as a fourth secondary cell of the base station a and is activated, and communication with the mobile communication terminal 50 is performed by cells 1 to 5 (cell 3 . . . “D”→“Sa4”).

At the time f, the amount of communication between the mobile communication terminal 50 and the base station a of the mobile communication terminal test device 10 is reduced and cell 3 stops communication with the mobile communication terminal 50 and is deactivated (cell 3 . . . “Sa4”→“D”).

At the time g, the amount of communication between the mobile communication terminal 50 and the base station a of the mobile communication terminal test device 10 is further reduced and cells 2, 4 and 5 stop communication with the mobile communication terminal 50 and is deactivated (cell 5 . . . “Sa3”→“D”, cell 4 . . . “Sa2”→“D”, and cell 2 . . . “Sa1”→“D”). In this way, cell 1 is set as the primary cell and is maintained in the activation state, and the other cells 2 to 5 are set as the secondary cells and are in the deactivation state.

### <First Example of Cell State Determination Process According to First Embodiment>

Here, in the first embodiment, as a first example of the cell state determination process of the cell state determination unit 19, a method of determining the activation/deactivation of the secondary cell by carrier aggregation will be described.

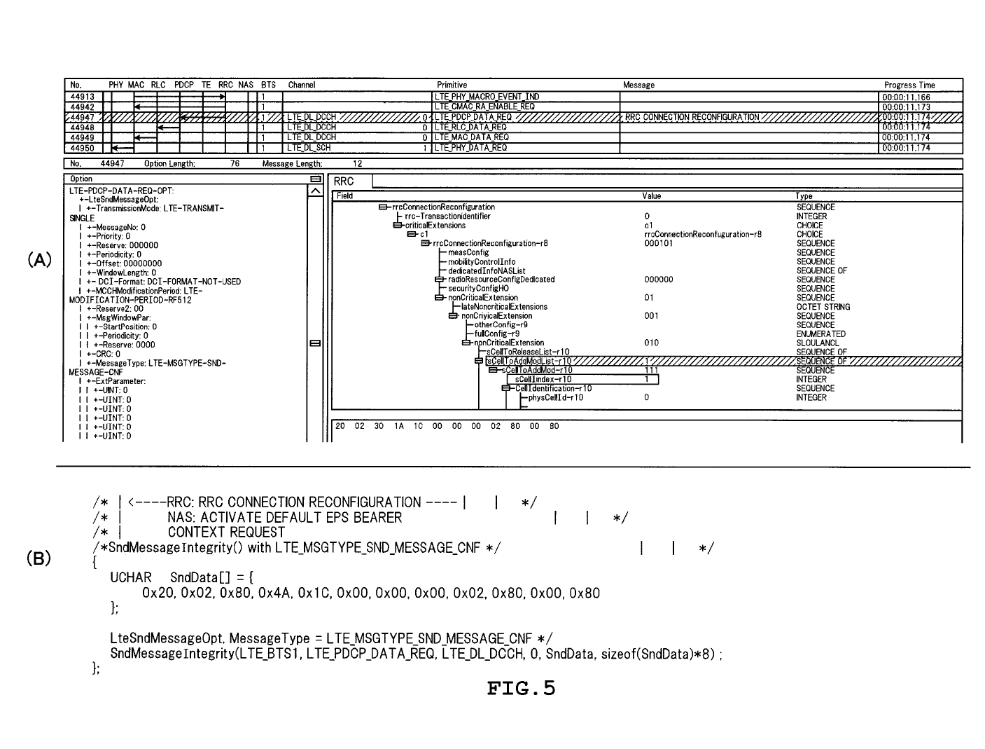

FIG. 5 is a diagram illustrating an example of information which is used to add (Configuration) and delete (Release) the secondary cell. FIG. 5(A) shows log information and FIG. 5(B) shows scenario information. The log information and the scenario information shown in FIGS. 5(A) and 5(B) are used to set the secondary cell at the time b in FIG. 4.

When the log information is acquired to determine the state of the cells, first, the cell state determination unit 19 searches for a log with a message name “RRC Connection Reconfiguration” from the log data 60. In the example shown in FIG. 5(A), a log with number “44947” corresponds to the log with the message name “RRC Connection Reconfiguration”. Then, the cell state determination unit 19 analyzes the content of the log information which is extracted by the search and checks whether “sCell To Add Mod List” (a parameter related to the addition of a cell) or “sCell To Release List” (a parameter related to the deletion of a cell) is included in parameters.

Then, when the parameter is included, the cell state determination unit 19 checks the value of “sCell Index” of the parameter and specifies a target cell, that is, any one of five cells (PHY units 31-1 to 31-5) which are simulated by the mobile communication terminal test device 10. Then, the cell state determination unit 19 acquires a time stamp using the time information 72 of the corresponding log in the log data 60 and sets the time stamp as a secondary cell addition or deletion time. In the example shown in FIG. 5(A), the time is “00:00:11.174”.

When the scenario information is acquired to determine the state of the cells, first, the cell state determination unit 19 monitors whether there is a command to transmit a message with a message name “RRC Connection Reconfiguration” in the content of the test scenario. Then, the cell state determination unit 19 analyzes the content of the message which is extracted by the monitoring and checks whether “sCell To Add Mod List” or “sCell To Release List” is included in the parameters. In the example shown in FIG. 5(B), the content of the message is represented by a hexadecimal value and a fifth byte “0x1C” includes the value of “sCell To Add ModList”.

Then, when the parameter is included, the cell state determination unit 19 checks the value of “sCell Index” of the parameter and specifies a target cell, that is, any one of the five cells (PHY units 31-1 to 31-5) which are simulated by the mobile communication terminal test device 10. Then, the cell state determination unit 19 sets the time when the corresponding portion is executed in the test scenario as the secondary cell addition or deletion time.

### <Second Example of Cell State Determination Process According to First Embodiment>

Next, as a second example of the cell state determination process of the cell state determination unit 19, a method of determining an activation/deactivation switching time will be described.

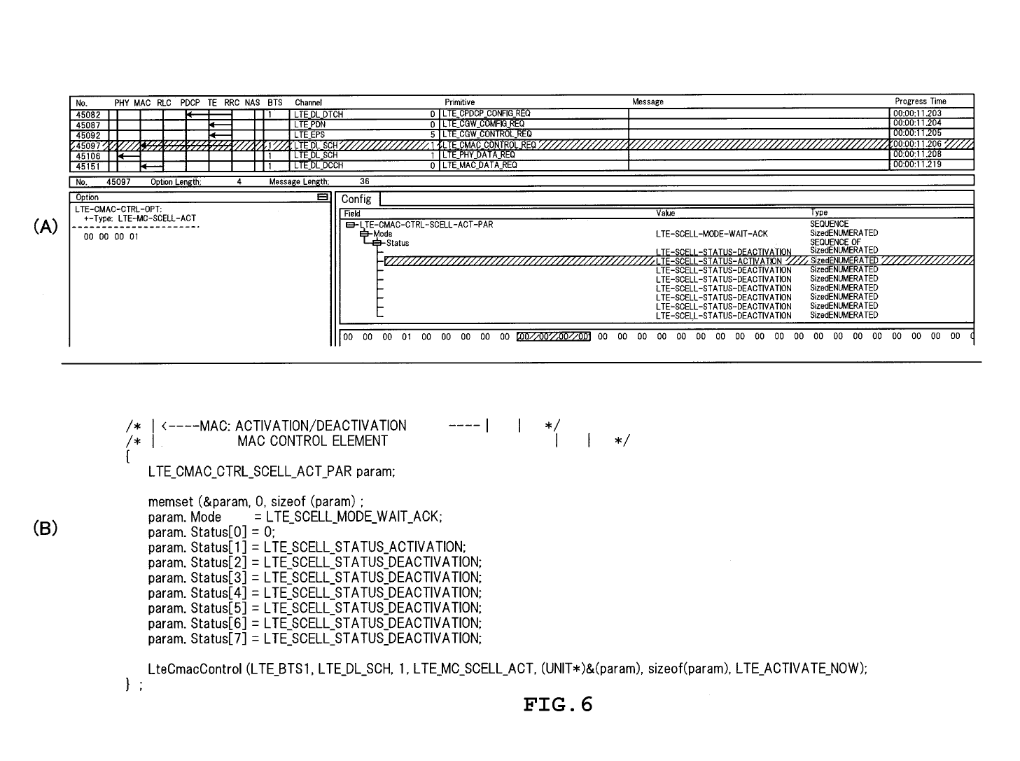

FIG. 6 is a diagram illustrating an example of information which is used to determine the activation/deactivation switching time of the secondary cell. FIG. 6(A) shows log information and FIG. 6(B) shows scenario information. The log information and the scenario information shown in FIGS. 6(A) and 6(B) are used to switch the setting of the activation/deactivation of the secondary cell at the times c and g in FIG. 4.

When the log information is acquired to determine the state of the cells, first, the cell state determination unit 19 searches for a log with a primitive name “LTE#CMAC#CONTROL#REQ” from the log data 60. In the example shown in FIG. 6(A), a log with number “45097” corresponds to the log. In this case, the primitive “LTE#CMAC#CONTROL#REQ” is used as an instruction to transmit “Activation/Deactivation MAC control elements” which means switching between activation and deactivation.

Then, the cell state determination unit 19 analyzes the content of the log information which is extracted by the search, checks the value of “Status” of the parameter, and specifies the state (Activation/Deactivation) of each cell. The description order of the value of the above-mentioned “Status” corresponds to the order of the value of the above-mentioned “sCell Index” (that is, the identification number of each cell). Then, the cell state determination unit 19 acquires a time stamp using the time information 72 of the corresponding log in the log data 60 and sets the time stamp as the secondary cell activation/deactivation switching time. In the example shown in FIG. 6(A), the time is “00:00:11.206”.

When the scenario information is acquired to determine the state of the cells, first, the cell state determination unit 19 monitors whether there is a command to transmit a primitive with a primitive name “LTE#CMAC#CONTROL#REQ” in the content of the test scenario.

Then, the cell state determination unit 19 analyzes the content of a corresponding message which is extracted by the monitoring, checks the value of “param.Status[x]” of the parameter, and specifies the state of each cell (Activation/Deactivation). Here, [x] corresponds to the value of the above-mentioned “sCell Index”. Then, the cell state determination unit 19 sets the time when the corresponding portion is executed in the test scenario as the activation/deactivation switching time of the secondary cell.

Instead of the above-mentioned method, a method may be used which directly searches for or monitors log information or scenario information including the information of “Activation/Deactivation MAC control elements”.

### <Third Example of Cell State Determination Process According to First Embodiment>

Next, as a third example of the cell state determination process of the cell state determination unit 19, a method of determining the check of the activation/deactivation state of the secondary cell will be described.

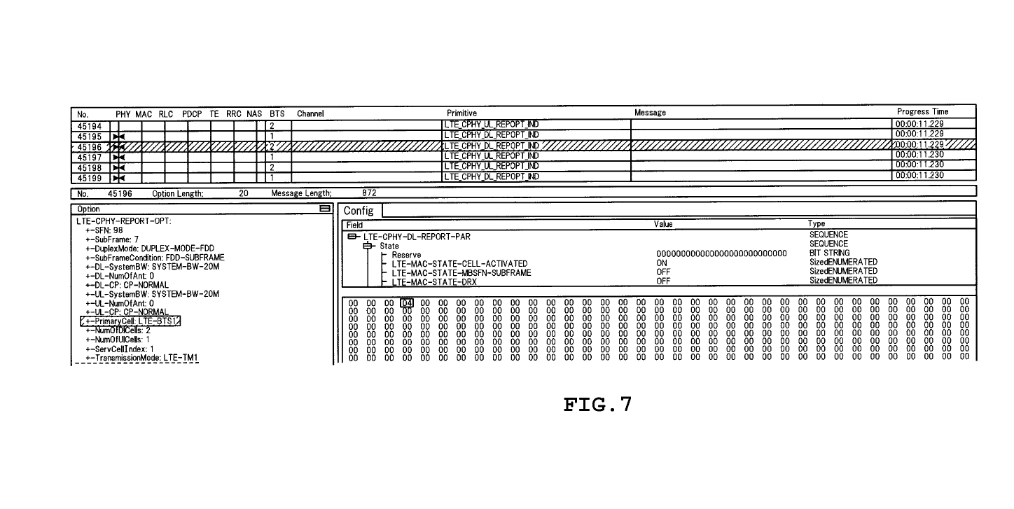

FIG. 7 is a diagram illustrating log information as an example of information which is used to determine the check of the activation/deactivation state of the secondary cell. The third example is another example of the method of checking the state of each cell using the log information and determines information indicating the internal state of the mobile communication terminal test device 10.

First, the cell state determination unit 19 searches for a log with a primitive name “LTE#CPHY#DL#REPORT#IND” and a status “LTE-MAC-STATE-CELL-ACTIVATED” in the log data 60. In the example shown in FIG. 7, a log with number “45196” corresponds to the log. Then, the cell state determination unit 19 analyzes the content of the corresponding log information which is extracted by the search, checks the value of “LTE-MAC-STATE-CELL-ACTIVATED”, and specifies the state (Activation/Deactivation) of each cell using “ON/OFF”. In addition, “LTE#CPHY#DL#REPORT#IND” is a primitive unique to the mobile communication terminal test device 10 and means a report for the status in the downlink. Furthermore, “LTE-MAC-STATE-CELL-ACTIVATED” is information indicating the activation/deactivation state of the cell. When the value of “LTE-MAC-STATE-CELL-ACTIVATED” is “ON”, “LTE-MAC-STATE-CELL-ACTIVATED” indicates activation. When the value is “OFF”, “LTE-MAC-STATE-CELL-ACTIVATED” indicates deactivation.

In this case, the primary cell and the secondary cell are identified and determined by the BTS number “1 or 2” and the value of “Primary Cell” in an option area (Option). In the example shown in FIG. 7, since the value of “Primary Cell” is “LTE-BTS1”, the BTS number “2” can be determined to be the secondary cell.

Instead of the above-mentioned method, a method may be used which directly searches for or monitors log information or scenario information including the information of “LTE-MAC-STATE-CELL-ACTIVATED”.

In this embodiment, as shown in FIG. 4, the state of each of a plurality of cells is displayed according to the time elapsed. Therefore, even when communication is performed using a plurality of cells at the same time, the tester visibly recognizes the display of the state of the cells during or after a test to easily check the state of the cells. At that time, it is possible to identify a plurality of communicable cells as the primary cell or the secondary cell and intuitively check various states of the cells, such as the activation/deactivation state of the secondary cell, using graphic information indicating the display of the state of the cells.

### Second Embodiment

### Structure of Second Embodiment

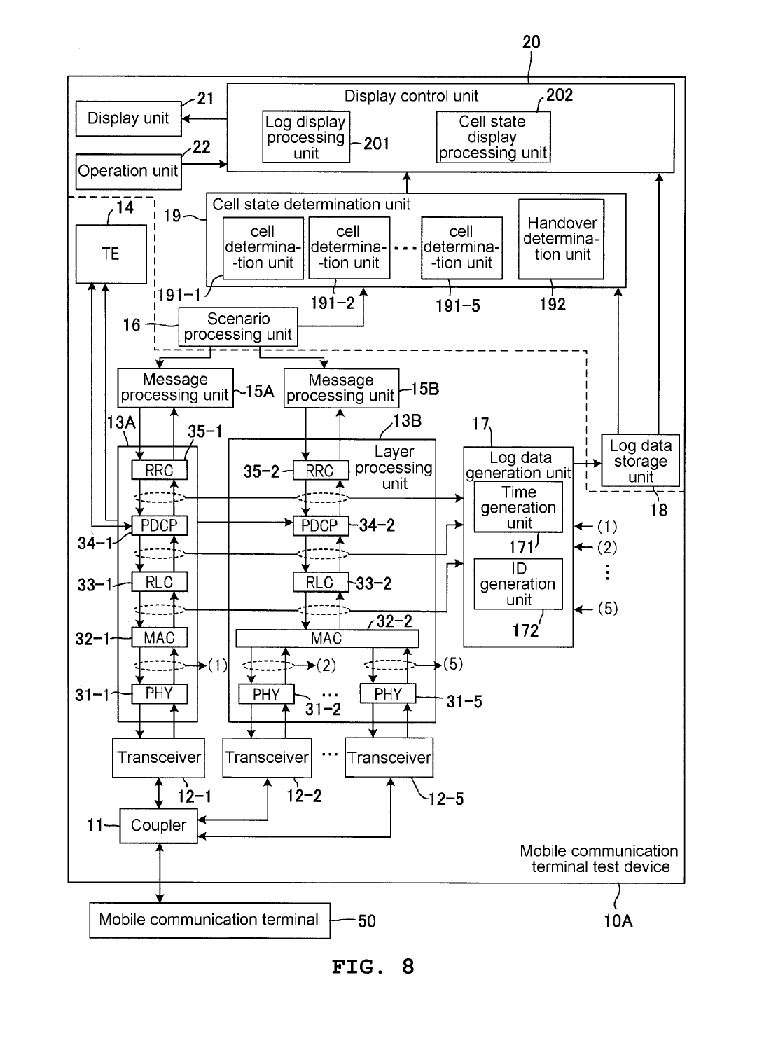

FIG. 8 is a block diagram illustrating the structure of a mobile communication terminal test device according to a second embodiment of the invention.

The second embodiment shows a structure in which a mobile communication terminal test device 10A simulates the operation of two base stations and handover is performed between a plurality of base stations. In this embodiment, the handover is assumed as a communication process between the cells of different base stations, particularly, a primary cell switching process between the base stations.

The mobile communication terminal test device 10A according to the second embodiment includes a coupler 11, transceivers 12-1 to 12-5, layer processing units 13A and 13B, a TE unit 14, message processing units 15A and 15B, a scenario processing unit 16, a log data generation unit 17, a log data storage unit 18, a cell state determination unit 19, a display control unit 20, a display unit 21, and an operation unit 22. In the second embodiment, the same components as those in the first embodiment are denoted by the same reference numerals and the description thereof will not be repeated. The description is focused on the components different from those in the first embodiment.

In order to simulate the operation of two base stations a and b, the mobile communication terminal test device 10A has different internal settings from those in the first embodiment and includes two types of layer processing units 13A and 13B and two types of message processing units 15A and 15B. That is, in the second embodiment, some of the functions of the layer processing unit 13, the message processing unit 15, the scenario processing unit 16, and the cell state determination unit 19 shown in FIG. 1 are changed.

The layer processing unit 13A includes a PHY unit 31-1, a MAC unit 32-1, an RLC unit 33-1, a PDCP unit 34-1, and an RRC unit 35-1 and the layer processing unit 13B includes PHY units 31-2 to 31-5, a MAC unit 32-2, an RLC unit 33-2, a PDCP unit 34-2, and an RRC unit 35-2.

The message processing units 15A and 15B process various messages which are exchanged with a mobile communication terminal 50 by the layer processing units 13A and 13B. The message processing unit 15A creates a request message for communication by one cell in the first base station a and acquires a response message to the request message. The message processing unit 15B creates a request message for communication by four cells in the second base station b and acquires a response message to the request message.

The scenario processing unit 16 controls the execution of a test including a handover procedure between the base stations a and b according to a test scenario in which the settings of the mobile communication terminal test device 10 and a test procedure are described. The log data generation unit 17 generates log data including log information for the test including the handover procedure and stores the log data in the log data storage unit 18.

As the determination of the state of the cells, the cell state determination unit 19 determines the occurrence/end state of the handover between the cell of the base station a and the cell of the base station b, on the basis of the scenario information from the scenario processing unit 16 or the log information from the log data storage unit 18, using a handover determination unit 192.

The display control unit 20 generates cell state display information including handover state display using a cell state display processing unit 202 and outputs the cell state display information to the display unit 21 such that the display unit 21 displays the state of the cells.

The mobile communication terminal 50 receives transmission signals from a plurality of peripheral base stations and acquires the reception quality information (Measurement Report) of each base station. When the reception quality of the transmission signal from the base station which is currently communicating with the mobile communication terminal 50 and handover to another base station is performed, the mobile communication terminal 50 transmits a handover request to the base station. When receiving the handover request, the base station determines whether handover is possible. When handover is possible, the base station transmits a handover instruction to another base station, which is a handover target, and the mobile communication terminal 50 which has received the handover request. Then, a handover process is performed between the base stations, which are a handover source and a handover target, and the mobile communication terminal 50 and connection between the mobile communication terminal 50 and the base station, which is a communication partner of the mobile communication terminal 50, is switched.

### <Operation (Cell State Display) of Second Embodiment>

Next, the display of the state of the cells (cell state display) in the second embodiment will be described.

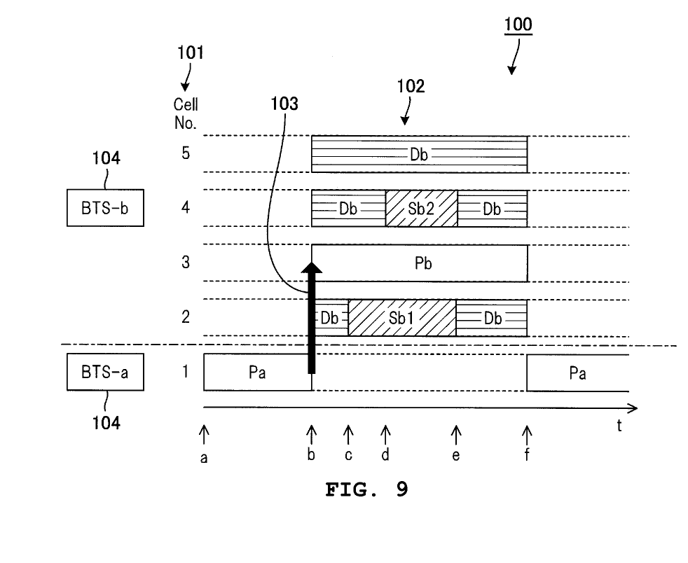

FIG. 9 is a diagram illustrating an example of the display of the state of cells on the display unit 21 in the second embodiment. FIG. 9 shows an example in which a plurality of base stations can perform communication using a maximum of five cells, using carrier aggregation, handover is performed between the base stations, and communication is performed, using a bundle of a plurality of cells, depending on the amount of communication. Here, a case will be described in which the mobile communication terminal test device 10A simulates the operation of two base stations a and b, the base station a uses cell 1, the base station b uses cells 2 to 5, handover from the base station a to the base station b is performed, and communication with the mobile communication terminal 50 to be tested is performed.

For the state of each of a plurality of cells, the cell state determination unit 19 determines the activation/deactivation state of each of cells 1 to 5, whether the cell in the activation state is a primary cell or one of secondary cells, and the occurrence/end state of handover. The determination of the state of the cells related to the handover will be described in detail below.

The cell state display processing unit 202 of the display control unit 20 acquires information about the determination result of the state of the cells by the cell state determination unit 19 and the scenario information or log information used to determine the state of the cells, creates display information for displaying the state of the cells, and outputs the display information to the display unit 21. In this way, a cell state display 100 shown in FIG. 9 is displayed on a display screen of the display unit 21.

The cell state display 100 includes a cell number (Cell No.) display 101, a state display 102, a handover display 103, and a base station display 104. In the state display 102 shown in FIG. 9, a small letter “a” of “Pa” indicates the communication state of the base station a and a small letter “b” of “Db”, “Pb”, and “Sb1” indicates the communication state of the base station b.

The handover display 103 is information indicating the execution state of handover at a handover occurrence point using the display of an arrow from a handover source to a handover target. The base station (BTS-a and BTS-b) 104 is information indicating the type of base station corresponding to each cell.

For the display of the state of handover as the state of the cells, handover display may be performed in response to a handover display operation instruction which is input from the operation unit by the tester.

In FIG. 9, the lateral direction indicates time and the state of the cells is changed from the left to the right over time, similarly to FIG. 4.

Next, the state of the cells at each of times a to f will be described.

At the time a, in the base station simulated by the mobile communication terminal test device 10A, cell 1 is set as the primary cell of the base station a and is activated, and communication with the mobile communication terminal 50 is performed by cell 1 (cell 1 . . . “Pa”).

At the time b, handover occurs due to a change in the state of a transmission path between the mobile communication terminal test device 10A and the mobile communication terminal 50 and the communication destination of the mobile communication terminal 50 is changed from the base station a (cell 1) to the base station b (cell 3). In this case, cell 3 is set as the primary cell of the base station b and is activated and communication with the mobile communication terminal 50 is started by the cell 3 (cell 3 . . . “Pb”). At the time b, the handover display 103 from cell 1 to cell 3 is displayed. Cells 2, 4, and 5 are set as the secondary cells of the base station b and are deactivated (cells 2, 4, and 5 . . . “Db”).

At the time c, the amount of communication between the mobile communication terminal 50 and the base station b of the mobile communication terminal test device 10A increases, cell 2 is set as a first secondary cell of the base station b and is activated, and communication with the mobile communication terminal 50 is performed by cell 3 and cell 2 (cell 2 . . . “Db”→“Sb1”).

At the time d, the amount of communication between the mobile communication terminal 50 and the base station b of the mobile communication terminal test device 10A further increases, cell 4 is set as a second secondary cell of the base station b and is activated, and communication with the mobile communication terminal 50 is performed by cell 3, cell 2, and cell 4 (cell 4 . . . “Db”→“Sb2”).

At the time e, the amount of communication between the mobile communication terminal 50 and the base station b of the mobile communication terminal test device 10A is reduced and cell 2 and cell 4 stop communication with the mobile communication terminal 50 and are deactivated (cell 2 . . . “Sb1”→“Db” and cell 4 . . . “Sb2”→“Db”).

At the time f, the connection between the mobile communication terminal 50 and the base station b of the mobile communication terminal test device 10A is cut and the mobile communication terminal 50 is connected to cell of another communicable base station a and performs communication. At that time, cell 1 is set as the primary cell of the base station a and is activated and communication with the mobile communication terminal 50 is started by cell 1 (cell 1 . . . “Pa”). In this case, since this is a communication disconnection and reconnection process, but is not a handover operation, the handover display 103 is not displayed. The communication disconnection intentionally occurs in the test scenario, or it unintentionally occurs due to defects in the mobile communication terminal 50.

### <First Example of Cell State Determination Process According to Second Embodiment>

Here, as a first example of the cell state determination process of the cell state determination unit in the second embodiment, a method of determining a handover start time will be described.

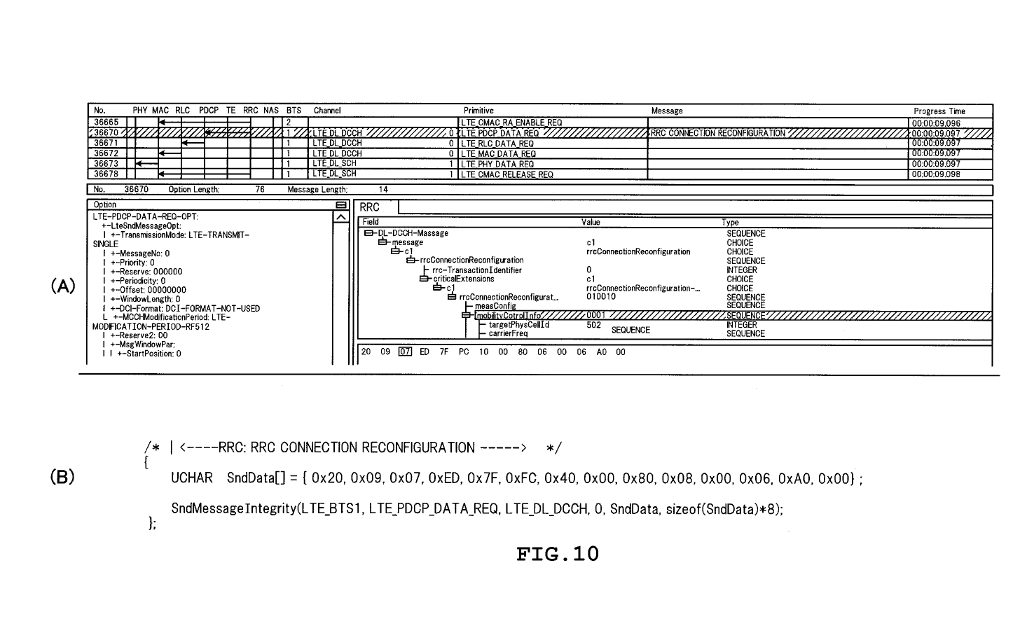

FIG. 10 is a diagram illustrating an example of information which is used to determine the handover start time. FIG. 10(A) shows log information and FIG. 10(B) shows scenario information. The log information and the scenario information shown in FIGS. 10(A) and 10(B) are used to reset connection during handover at the time b in FIG. 9.

When the log information is acquired to determine the state of the cells, first, the cell state determination unit 19 searches for a log with a message name “RRC Connection Reconfiguration” from the log data 60. In the example shown in FIG. 10(A), a log with number “36670” corresponds to the log. Then, the cell state determination unit 19 analyzes the content of the log information which is extracted by the search and checks whether “mobility Control Info” (a parameter related to terminal control) is included in the parameters. The value of the parameter “mobility Control Info” is not absolutely necessary. When the value of the parameter, not the settings of handover start, is absent, the parameter “mobility Control Info” is not present. Therefore, it may be determined whether the parameter is present.

Then, when the parameter is included, the cell state determination unit 19 acquires a time stamp using the time information 72 of the corresponding log in the log data 60 and sets the time stamp as a handover start time. In the example shown in FIG. 10(A), the time is “00:00:09.097”.

When the scenario information is acquired to determine the state of the cells, first, the cell state determination unit 19 monitors whether there is a command to transmit a message with a message name “RRC Connection Reconfiguration” in the content of the test scenario. Then, the cell state determination unit 19 analyzes the content of the message which is extracted by the monitoring and checks whether “mobility Control Info” is included in the parameters. In the example shown in FIG. 10(B), the content of the message is represented by a hexadecimal value and a third type “0x07” includes the value of “mobility Control Info”.

Then, when the parameter is included, the cell state determination unit 19 sets the time when a corresponding portion is executed in the test scenario as the handover start time.

### <Second Example of Cell State Determination Process According to Second Embodiment>

Next, as a second example of the cell state determination process of the cell state determination unit 19, a method of determining a handover end time will be described.

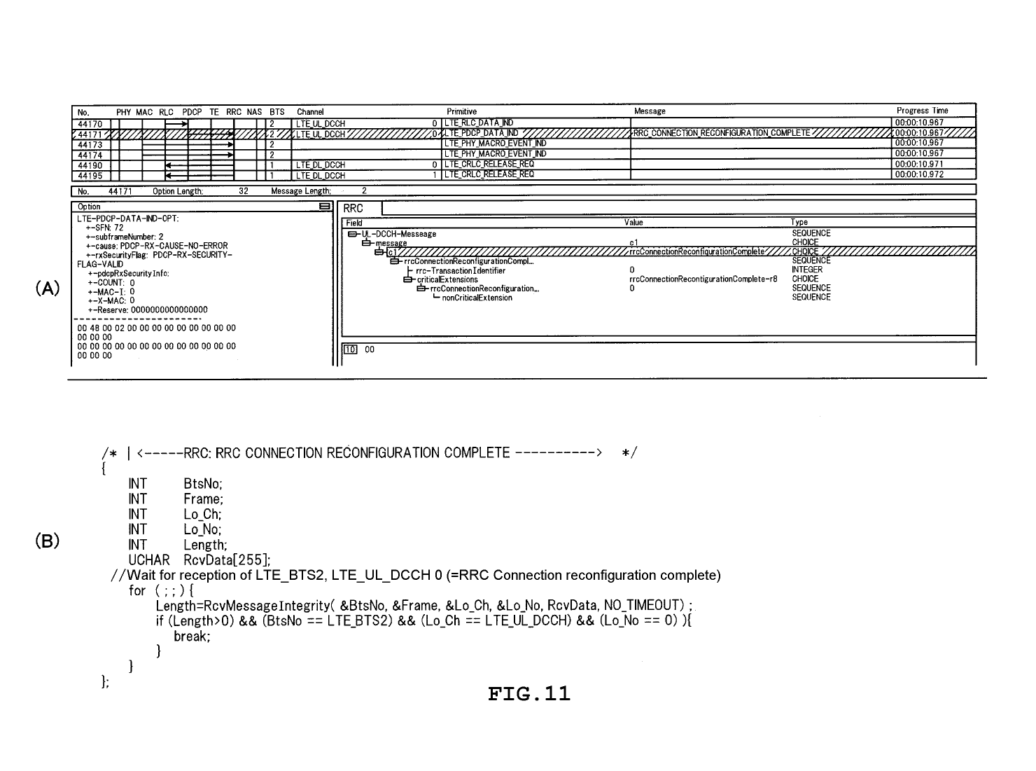

FIG. 11 is a diagram illustrating an example of information which is used to determine the handover end time. FIG. 11(A) shows log information and FIG. 11(B) shows scenario information. The log information and the scenario information shown in FIGS. 11(A) and 11(B) are used to reset connection when handover is performed at the time b of FIG. 9.

When the log information is acquired to determine the state of the cells, first, the cell state determination unit 19 searches for a log with a message name “RRC Connection Reconfiguration Complete” from the log data 60. In the example shown in FIG. 11(A), a log with number “44171” corresponds to the log.

Then, when a corresponding message is extracted by the search, the cell state determination unit 19 acquires a time stamp using the time information 72 of the corresponding log in the log data 60 and sets as the time stamp as the handover end time. In the example shown in FIG. 11(A), the time is “00:00:10.967”.

When the scenario information is acquired to determine the state of the cells, first, the cell state determination unit 19 monitors whether there is a process of receiving a message with a message name “RRC Connection Reconfiguration Complete” in the content of the test scenario.

When a corresponding message is extracted by the monitoring, the cell state determination unit 19 sets the time when the reception process is performed in the test scenario or the time when a transmission command is executed immediately after the reception process as the handover end time.

The handover end time may be determined by the following other determination methods. In this case, the cell state determination unit 19 monitors whether there is a notice indicating the reception of a message with a message name “RRC Connection Reconfiguration Complete” in notification from the message processing unit 15 to the scenario processing unit 16. Then, when a corresponding message is extracted by the monitoring, the cell state determination unit 19 sets the time when the reception notice is received as the handover end time.

In this embodiment, as shown in FIG. 9, the state of each of a plurality of cells is displayed depending on the time elapsed. When handover occurs, the state of the handover is displayed. Therefore, even when communication is performed using a plurality of cells at the same time, the tester can easily check the occurrence state of handover during or after a test. At that time, it is possible to intuitively check the start/end of handover and the state of cells related to handover, such as a handover source cell and a handover target cell, on the basis of graphic information about handover display.

### <First Modification Example of Cell State Display>

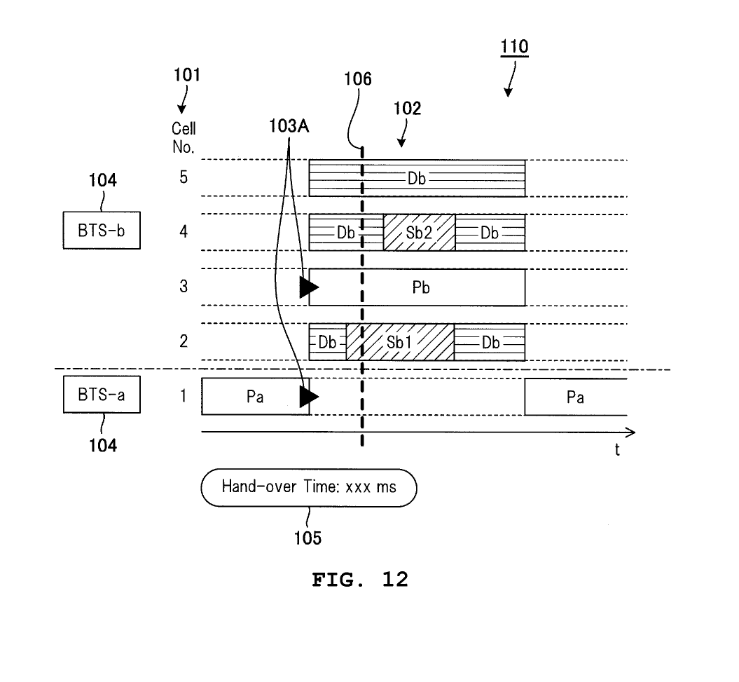

Next, a first modification example of the display of the state of the cells according to this embodiment will be described. FIG. 12 is a diagram illustrating the first modification example of the display of the state of the cells on the display unit 21 in this embodiment.

A cell state display 110 according to the first modification example includes a cell number (Cell No.) display 101, a state display 102, a handover display 103A, a base station display 104, a handover procedure time display 105, and a log position mark 106.

The handover display 103A is another example of the display of a handover mark different from that shown in FIG. 9 and a handover source cell and a handover target cell are represented by triangles.

The handover procedure time (Hand-over Time:) 105 indicates the time from a handover start time to a handover end time and is information indicating the processing time required for handover.

The log position mark 106 is information indicating the position (corresponding time) of the log information which is currently being displayed when the log is displayed on the same screen as or a different screen from that on which the state of the cells is displayed.

As such, when handover occurs, the handover procedure time display 105 enables the tester to check the time required for a process from the start to the end of handover.

### <Second Modification Example of Cell State Display>

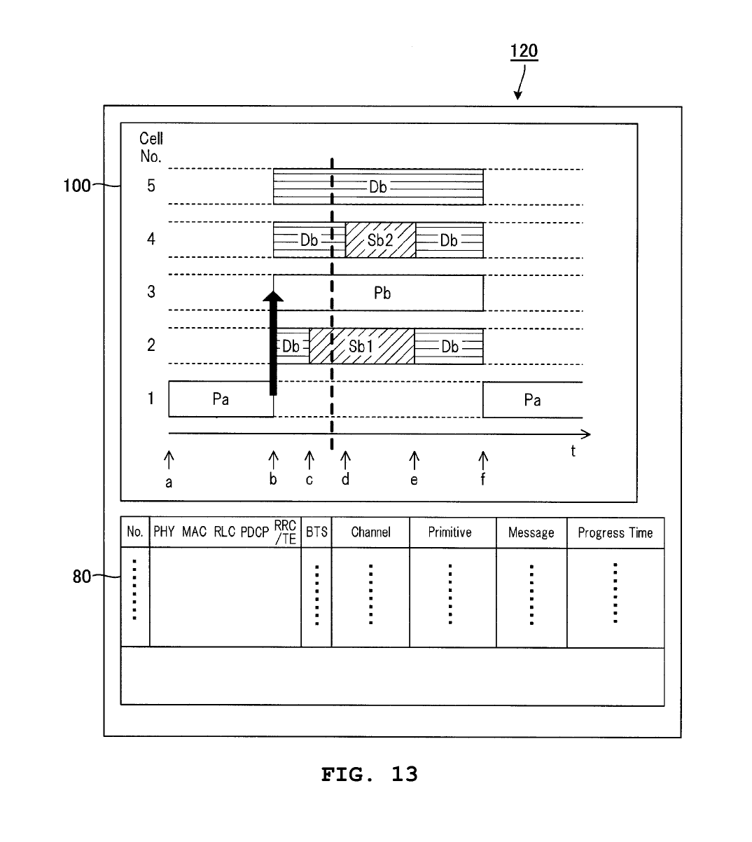

Next, a second modification example of the display of the state of the cells in this embodiment will be described. FIG. 13 is a diagram illustrating the second modification example of the display of the state of the cells on the display unit 21 in this embodiment.

A cell state display 120 according to the second modification example is an example in which the cell state display 100 indicating the activation/deactivation state and handover state of each cell and the log display 80 indicating the log information are displayed side by side on the same screen.

As such, when the cell state display 100 and the log display 80 are displayed at the same time, it is possible to perform an operation of checking the state of each cell for a predetermined period of time and an operation of checking the log information at a specific time for a predetermined period of time on the same screen. Therefore, the tester can easily check the state of each cell.

(Process Procedure in this Embodiment)

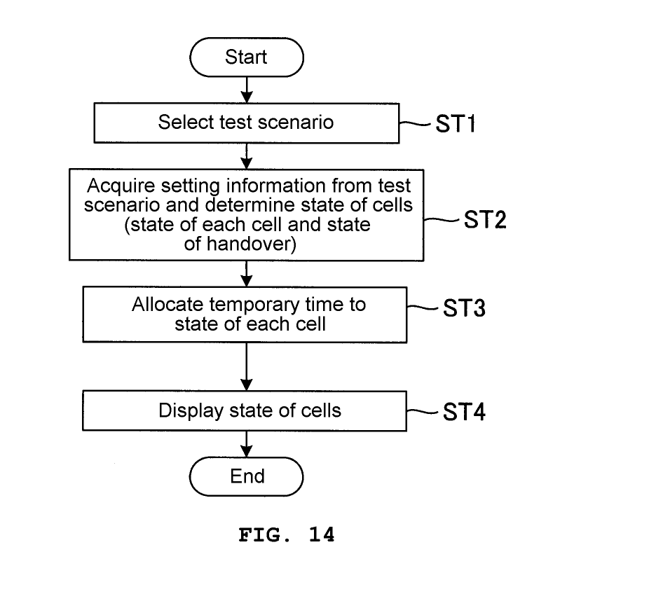

Next, the process procedure of the mobile communication terminal test devices according to the first and second embodiments will be described. FIGS. 14 to 16, which will be described below, show the process procedure of each unit, particularly, the scenario processing unit 16, the cell state determination unit 19, and the display control unit 20 in the mobile communication terminal test devices 10 and 10A according to these embodiments.

FIG. 14 is a flowchart illustrating a process procedure related to the check of the test scenario before a test.

When the tester operates the operation unit 22 to select a test scenario, the scenario processing unit 16 selects the test scenario which is instructed to be selected and is ready to perform a process (Step ST1).

Then, the cell state determination unit 19 analyzes the scenario information of the test scenario selected by the scenario processing unit 16, acquires setting information from the test scenario, and determines the state of the cells (Step ST2). As the state of the cells, the activation/deactivation state of each cell, the state of the primary cell/the secondary cell, and the occurrence/end state of handover are determined.

Then, the cell state determination unit 19 allocates a temporary time to each cell state to set the occurrence/end time of each cell state (Step ST3).

Then, the display control unit 20 generates display information for the state of the cells, outputs the display information to the display unit 21, and displays the state of the cells on the display screen of the display unit 21 (Step ST4).

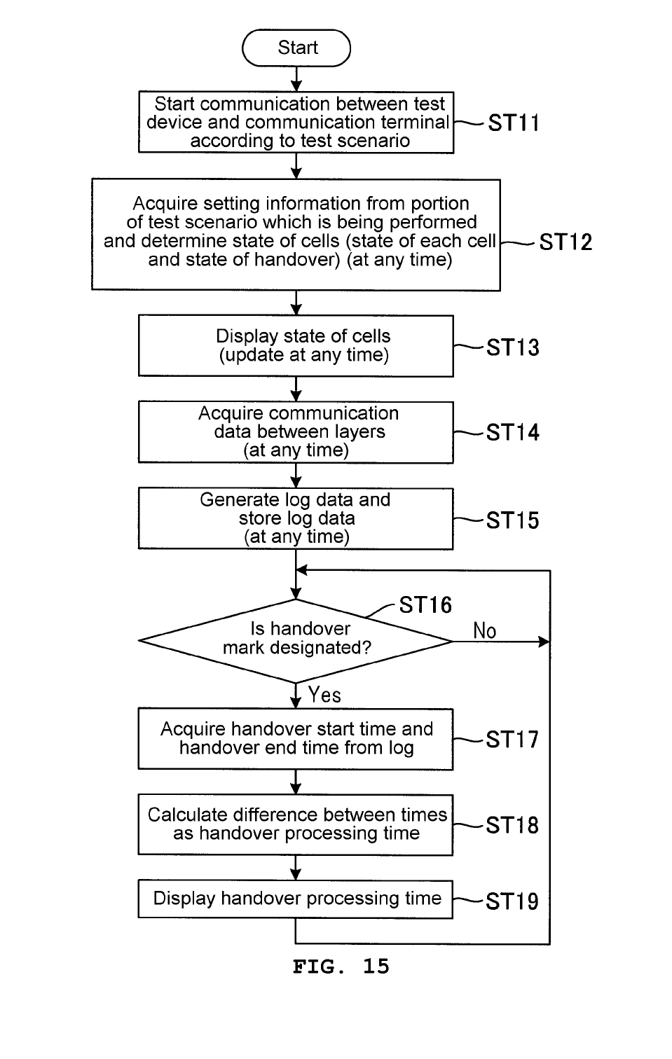

FIG. 15 is a flowchart illustrating a process procedure related to the real-time display of the state of the cells during a test.

The scenario processing unit 16 operates each unit of the mobile communication terminal test device according to the test scenario to perform a test on the basis of the selected test content (Step ST11). In this case, the layer processing unit 13 forms a processing unit with a structure corresponding to the settings based on the test scenario and processes each layer such that communication with the mobile communication terminal 50 is performed.

The cell state determination unit 19 analyzes the scenario information of the test scenario to be executed, acquires setting information from a portion of the test scenario which is being executed, and determines the state of the cells (Step ST12). As the state of the cells, the activation/deactivation state of each cell, the state of the primary cell/the secondary cell, and the occurrence/end state of handover are determined. At that time, the time when a command to transmit the state of the corresponding cell is issued or the time when a reception notice is received is used as the occurrence/end time of each cell state. The state of the cells is determined at any time.

Then, the display control unit 20 generates display information for the state of the cells determined by the cell state determination unit 19, outputs the display information to the display unit 21, and displays the state of the cells on the display screen of the display unit 21 (Step ST13). The state of the cells is displayed at any time, for example, whenever the state of the cells is determined. For the display of the state of handover, an example in which handover display and handover procedure time display are performed in response to an instruction to operate a handover mark indicating a handover occurrence point, which is an example a handover display operation instruction from the tester, will be described.

The log data generation unit 17 acquires communication data which is transmitted between the layers by the layer processing unit 13 (Step ST14), creates log data including log information for each process, and stores the log data in the log data storage unit 18 (Step ST15). The acquisition of the communication data between the layers, the generation of the log data, and the storage of the log data are performed at any time.

The display control unit 20 determines whether a handover mark is designated by the tester through the operation unit 22 (Step ST16). When the handover mark is designated (Step ST16: Yes), the handover determination unit 192 acquires a handover start time and a handover end time from the log information of the log data (Step ST17).

Then, the handover determination unit 192 calculates a difference between the handover start time and the handover end time as the handover procedure time (Step ST18). Then, the display control unit 20 generates display information for the calculated handover procedure time, outputs the display information to the display unit 21, and displays the handover procedure time on the display screen of the display unit 21 (Step ST19).

When the handover mark is not designated (Step ST16: No), the display control unit 20 repeatedly performs the determination in Step ST16 at a predetermined time interval until the handover mark is designated, or the process proceeds to Steps ST12 to ST15.

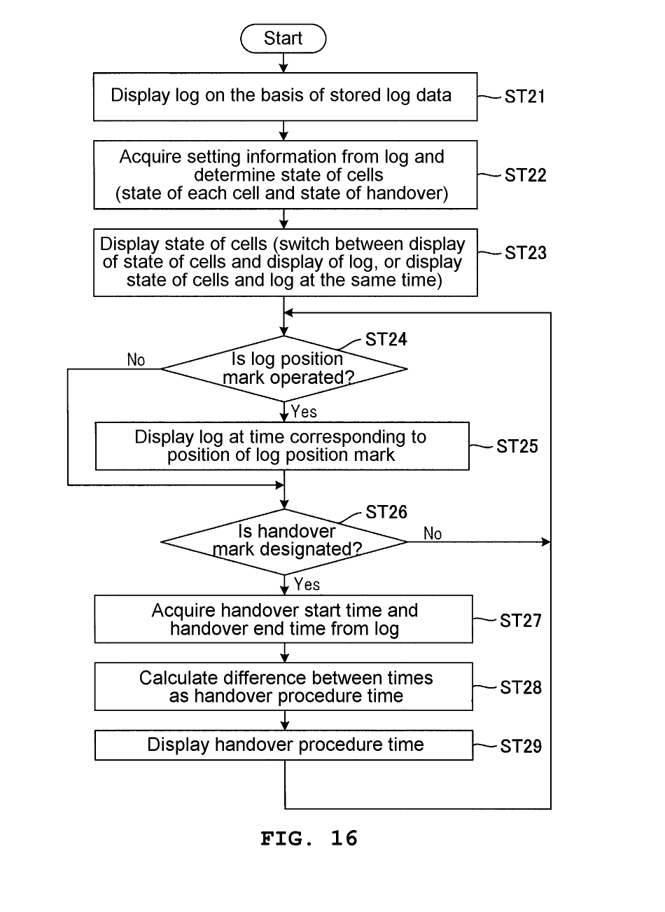

FIG. 16 is a flowchart illustrating the procedure of the process related to the check of the log information and the display of the state of the cells after a test.

The display control unit 20 acquires the log data stored in the log data storage unit 18, generates log display information, outputs the log display information to the display unit 21, and displays the log information on the display screen of the display unit 21 (Step ST21).

In addition, the cell state determination unit 19 acquires the log data from the log data storage unit 18, acquires setting information from the log information of the log data, and determines a cell state (Step ST22). As the state of the cells, the activation/deactivation state of each cell, the state of the primary cell and the secondary cell, and the occurrence/end state of handover are determined. At that time, time information of the log related to the corresponding cell state is acquired and used as the occurrence/end time of each cell state.

Then, the display control unit 20 generates display information for the cell state determined by the cell state determination unit 19, outputs the display information to the display unit 21, and displays the state of the cells on the display screen of the display unit 21 (Step ST23). The display of the state of the cells and the display of the log are switched, or they are performed at the same time. Here, for the display of a handover state, an example in which handover and the handover procedure time are displayed in response to an operation of designating a handover mark indicating a handover occurrence point, which is an example of a handover display operation instruction from the tester, will be described. In addition, for the display of the log information, an example, in which a log is displayed in response to an operation of designating a log position mark indicating a log display time position, which is an example of a log display operation instruction from the tester, will be described.

Then, the display control unit 20 determines whether the log position mark is designated by the tester through the operation unit 22 (Step ST24). When the log position mark is designated (Step ST24: Yes), the display control unit 20 generates display information for the log at the time corresponding to the position of the log position mark, outputs the display information to the display unit 21, and displays the log at the time on the display screen of the display unit 21 (Step ST25). In contrast, when the log position mark is not designated (Step ST24: No), the display control unit 20 skips Step ST25 and proceeds to the next Step ST26.

When the tester inputs an operation instruction to move the log position mark in the display of the log corresponding to the log position mark, it is possible to move the log display time in operative association with the log position mark and to change the log display position.

Then, the display control unit 20 determines whether the handover mark is designated by the tester through the operation unit 22 (Step ST26). When the handover mark is designated (Step ST26: Yes), the handover determination unit 192 acquires the handover start time and the handover end time from the log information of the log data (Step ST27).

Then, the handover determination unit 192 calculates the difference between the handover start time and the handover end time as the handover procedure time (Step ST28). Then, the display control unit 20 generates display information for the calculated handover procedure time, outputs the display information to the display unit 21, and displays the handover procedure time on the display screen of the display unit 21 (Step ST29).

In contrast, when the handover mark is not designated (Step ST26: No), the display control unit 20 returns to Step ST24 in which it is determined whether there is a log position mark, or it proceeds to Steps ST22 and ST23 to performs a process of displaying the state of the cells for another period of time.

According to the above-described embodiments of the invention, when communication using a plurality of cells is tested, the tester can easily check the state of the cells, such as the activation/deactivation state of each cell or the state of handover, using graphic information for cell state display.

In the above-described embodiments, the mobile communication terminal test device 10 is shown as a single device in FIG. 1 and the mobile communication terminal test device 10A is shown as a single device in FIG. 8. However, the structure of the device is not limited thereto. For example, display and operation control and communication signal processing may be performed by a separate information processing device including a processor and a memory, such as a personal computer (PC). In this case, in FIGS. 1 and 8, the scenario processing unit 16, the log data storage unit 18, the cell state determination unit 19, the display control unit 20, the display unit 21, and the operation unit 22 which are divided by a dashed line can be implemented by the PC.

In the above-described embodiments, the mobile communication terminal test device for the mobile communication terminal which can perform communication based on LTE-Advanced, which is a communication standard, is provided. However, the invention is not limited thereto. The invention can be applied to various types of communication systems using various communication protocols as long as they can perform the test according to a test scenario, communicate with the mobile communication terminal to acquire log information, and analyze the test scenario or the log information to determine the state of cells.

In the invention, the mobile communication terminal test device may be implemented by a device. The invention can be implemented by a program which causes a computer to function as the mobile communication terminal test device. In addition, the invention can be implemented by a mobile communication terminal test method including each operation (step) performed by the mobile communication terminal test device. That is, the invention can be implemented by any one device, method, and program categories.

Various embodiments of the invention have been described with reference to the drawings. However, the present disclosure is not limited to the above-mentioned examples. It will be apparent to those skilled in the art that various modifications and changes can be made within the scope of the claims and it will be understood by those skilled in the art that the modifications and changes are also included in the technical range of the present disclosure. In addition, the components in the above-described embodiments may be arbitrarily combined with each other, without departing from the scope and spirit of the present disclosure.

### DESCRIPTION OF REFERENCE NUMERALS AND SIGNS

10, 10A: MOBILE COMMUNICATION TERMINAL TEST DEVICE
12-1 TO 12-5: TRANSCEIVER
13, 13A, 13B: LAYER PROCESSING UNIT
15, 15A, 15B: MESSAGE PROCESSING UNIT
16: SCENARIO PROCESSING UNIT
17: LOG DATA GENERATION UNIT
171: TIME GENERATION UNIT
172: ID GENERATION UNIT
18: LOG DATA STORAGE UNIT
19: CELL STATE DETERMINATION UNIT
191-1 TO 191-5: CELL DETERMINATION UNIT
192: HANDOVER DETERMINATION UNIT
20: DISPLAY CONTROL UNIT
201: LOG DISPLAY PROCESSING UNIT
202: CELL STATE DISPLAY PROCESSING UNIT
21: DISPLAY UNIT
22: OPERATION UNIT
50: MOBILE COMMUNICATION TERMINAL
60: LOG DATA
80: LOG
90, 100, 110, 120: CELL STATE
91, 101: CELL NUMBER
92, 102: STATE
103, 103A: HANDOVER
104: BASE STATION
105: HANDOVER PROCEDURE TIME
106: LOG POSITION MARK

What is claimed is:

1. A mobile communication terminal test device that communicates with a mobile communication terminal using a plurality of cells to test the mobile communication terminal, comprising:
a display unit;
a cell state determination unit that determines a state of the plurality of cells in the communication; and
a display control unit that displays a screen indicating the determined state of the plurality of cells, which corresponds to an elapsed time in the communication, on the display unit.

2. The mobile communication terminal test device according to claim 1, further comprising:
a scenario processing unit that controls a procedure of the communication according to a test scenario,
wherein the cell state determination unit acquires scenario information when the test scenario is performed and determines the state of the plurality of cells before or during the test on the basis of the acquired scenario information.

3. The mobile communication terminal test device according to claim 1, further comprising:
a layer processing unit that performs a process related to a hierarchized communication protocol in the communication;
a log data generation unit that generates log data including log information of the process performed by the layer processing unit; and
a log data storage unit that stores the log data,
wherein the cell state determination unit acquires the log information of the stored log data and determines the state of the plurality of cells at a predetermined time in the test on the basis of the acquired log information.

4. The mobile communication terminal test device according to claim 3,
wherein the display control unit displays the state of the plurality of cells and displays a log including the log information at the time, in response to a log display operation instruction from an operation unit.

5. The mobile communication terminal test device according to claim 1,
wherein the cell state determination unit determines whether each cell is a primary cell or one of secondary cells as the state of the plurality of cells, and
the display control unit displays the determined state of the each cell so as to be recognized.

6. The mobile communication terminal test device according to claim 1,
wherein the cell state determination unit determines an activation or deactivation state of each cell as the state of the plurality of cells, and
the display control unit displays the determined activation or deactivation state so as to be recognized.

7. The mobile communication terminal test device according to claim 3,
wherein the layer processing unit performs a process of simulating a plurality of base stations,
the cell state determination unit determines whether a handover occurs between different base stations, and
the display control unit displays the determined handover state so as to be recognized.

8. The mobile communication terminal test device according to claim 7,
wherein the display control unit performs a handover display including a handover procedure time related to the handover, in response to a handover display operation instruction from an operation unit.

9. A mobile communication terminal test method that communicates with a mobile communication terminal using a plurality of cells to test the mobile communication terminal, comprising:
a cell state determination step of determining a state of the plurality of cells in the communication; and
a display step of displaying a screen indicating the determined state of the plurality of cells which corresponds to an elapsed time in the communication.

10. The mobile communication terminal test method according to claim 9, further comprising:
a scenario processing step of controlling a procedure of the communication according to a test scenario,
wherein the cell state determination step acquires scenario information when the test scenario is performed and determines the state of the plurality of cells before or during the test on the basis of the acquired scenario information.

11. The mobile communication terminal test method according to claim 9, further comprising:
a layer processing step of performing a process related to a hierarchized communication protocol in the communication;
a log data generation step of generating log data including log information of the process performed in the layer processing step; and
a log data storage step of storing the log data,
wherein the cell state determination step acquires the log information of the stored log data and determines the state of the plurality of cells at a predetermined time in the test on the basis of the acquired log information.

12. The mobile communication terminal test method according to claim 11,
wherein the display step displays the state of the plurality of cells and displays a log including the log information at the time, in response to a log display operation instruction from an operation unit.

13. The mobile communication terminal test method according to claim 9,
wherein the cell state determination step determines whether each cell is a primary cell or one of secondary cells as the state of the plurality of cells, and
the display step displays the determined state of the each cell so as to be recognized.

14. The mobile communication terminal test method according to claim 9,
wherein the cell state determination step determines an activation or deactivation state of each cell as the state of the plurality of cells, and
the display step displays the determined activation or deactivation state so as to be recognized.

15. The mobile communication terminal test method according to claim 11,
wherein the layer processing step performs a process of simulating a plurality of base stations,
the cell state determination step determines whether a handover occurs between different base stations, and
the display step displays the determined handover state so as to be recognized.

16. The mobile communication terminal test method according to claim 15,
wherein the display step performs a handover display including a handover procedure time related to the handover, in response to a handover display operation instruction.
